(19) United States
(12) Patent Application Publication
(10) Pub. No.: US 2004/0149287 A1
(43) Pub. Date: Aug. 5, 2004

(54) Two-shot injection molded nasal/oral mask

(76) Inventor: David Namey JR., New Kensington, PA (US)

Correspondence Address: MICHAEL W. HAAS, INTELLECTUAL PROPERTY COUNSEL, RESPIRONICS, INC., 1010 MURRY RIDGE LANE, MURRYSVILLE, PA, 15668, US

(21) Appl. No.: 10/764,108

(22) Filed: Jan. 23, 2004

Related U.S. Application Data
(62) Division of application No. 09/924,849, filed on Aug. 8, 2001, now abandoned.
(60) Provisional application No. 60/224,912, filed on Aug. 11, 2000.

(51) Int. Cl. A62B 18/02

(52) U.S. Cl. 128/205.25; 264/255; 264/328.8

(57) ABSTRACT

A mask that communicates a flow of breathing gas with an airway of a user is formed by a two-shot injection molding process. The mask includes a mask body and a mask seal member, at least a portion of which is molded to the mask body by a two-shot injection molding process while the mask body is cooling and incompletely cured. The mask seal member, or a portion thereof, is molecularly bonded to the mask body as a consequence of the two-shot injection molding process.

### BACKGROUND OF THE INVENTION

1. Field of the Invention

The present invention pertains to a nasal/oral mask for use in communicating a flow of breathing gas to an airway of user in a pressure support system, and, in particular, to a mask in which both the mask body and at least a portion of a mask seal are formed and joined using a two-shot injection molding process.

2. Description of the Related Art

Two-part molded nasal and nasal/oral masks are available for communicating a flow of breathing gas from a patient circuit to an airway of a patient in a pressure support system. Such masks consist of mask seal, also known as a mask cushion, which is the portion of the mask that contacts the patient, and a mask body to which the mask seal is attached. The mask body couples to the patient circuit for communicating the flow of breathing gas to the patient. In conventional masks, the mask seal is bonded to the mask body either mechanically or with an adhesive.

There are several disadvantages associated with conventional two-part masks. For example, mechanically bonding the mask seal with the mask body requires providing structures in the mask seal, the mask body, or both, that allow for the mechanical linkage between the two components. This typically requires using additional material to form the mask body, seal, or both, and increases the complexity of the design and manufacture of the mask. Adhesively bonding the mask seal to the mask body requires that an adhesive be applied to the mask seal, mask body, or both, thereby increasing the materials needed to produce the mask. In addition, both mechanical or adhesive bonding typically require hand assembly or hand manipulation of the two parts of the mask, as well as application of the adhesive, which is expensive and time-consuming.

### SUMMARY OF THE INVENTION

Accordingly, it is an object of the present invention to provide a mask for communicating a flow of breathing gas to an airway of a patient that overcomes the shortcomings of conventional two-part masks. This object is achieved according to one embodiment of the present invention by providing a mask that includes a mask body and a mask seal member (mask cushion), where at least a portion of the mask seal member is molded to the mask body using a two-shot injection molding process while the mask body is cooling and incompletely cured. The mask seal member or a portion thereof is molecularly bonded to the mask body as a consequence of the two-shot injection molding process.

It is yet another object of the present invention to provide a pressure support system using such a mask.

It is a still further object of the present invention to provide a method of forming such a mask that does not suffer from the disadvantages associated with conventional mask manufacturing techniques. This object is achieved by providing a two-shot injection molding method of forming a mask that includes (1) providing a mask mold, (2) injecting a first material into the mask mold to define a mask body, (3) injecting a second material into the mask mold while the mask body is cooling and incompletely cured to define at least a portion of a mask seal member for the mask. The mask seal member or a portion thereof is molecularly bonded to the mask body as a consequence of the second material being injected into the mask mold in this manner.

It is a further object of the present invention to provide a mask manufactured according to the process set forth in the immediately preceding paragraph.

These and other objects, features and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 is a side view of a mask manufactured in accordance with the two-shot injection molding technique of the present invention;

FIG. 2 is a cross-sectional view of the mask of FIG. 1 schematically shown in a typical pressure support system;

FIG. 3 is a perspective view of a molding apparatus for forming a two-shot injection molded mask in accordance with the principles of the present invention;

FIGS. 4A and 4B are cross sectional views of portions of the molding apparatus of FIG. 3 schematically illustrating two steps involved in forming masks using the two-shot injection molding technique;

FIG. 5 is a perspective view, partially in section, of second embodiment of a mask manufactured in accordance with the two-shot injection molding technique of the present invention;

FIG. 6 is a perspective view of the mask of FIG. 5 with the exterior or second flap seal member removed;

FIG. 7 is a detailed view of the mask body and second flap seal member interface in the mask of FIG. 5; and

FIG. 8 is a cross-sectional view of the mask of FIG. 5 further including a coupling member molded to the mask body in accordance with the two-shot injection molding technique of the present invention.

### DETAILED DESCRIPTION OF THE PRESENTLY PREFERRED EMBODIMENTS OF THE INVENTION

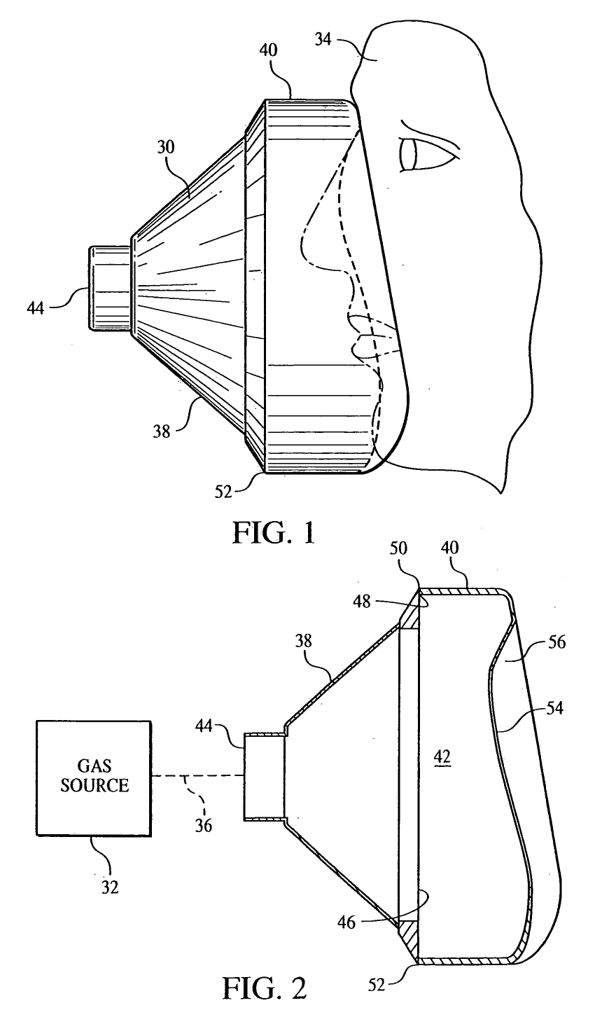

FIGS. 1 and 2 illustrate a first exemplary embodiment of a mask 30 manufactured by means of a two-shot injection molding technique in accordance with the principles of the present invention. Mask 30 is used in a medical environment to deliver a flow of gas from a gas source 32, such as, a ventilator, pressure support device (e.g., CPAP, bi-level, or auto-titration device), pressurized tank of oxygen or an oxygen mixture, or oxygen concentrator, to an airway of a patient 34. Typically a flexible conduit 36, referred to as a patient circuit and which is shown schematically as a dashed line in FIG. 2, couples the gas source to the mask in a pressure support system for delivering a flow of breathing gas from the gas source to the patient.

Mask 30 includes a mask body 38 and a mask seal member 40. The mask seal member is the portion of the mask that contacts the patient, thereby coupling the mask to the user to enable the flow of breathing gas to be delivered to the airway of the user. As such, the mask seal member must provide a relatively tight seal with the patient to minimize leakage of gas from the system. Mask 30 is typically worn by a patient for a prolonged period of time while a pressurized flow of gas is delivered to the patient. For example, patients suffering from sleep apnea typically wear a mask throughout the night in order for a flow of breathing gas to be delivered to their airway at a pressure elevated above the ambient atmospheric pressure as a treatment for this condition. Therefore, mask seal member 40 is preferably made from a lightweight, flexible, and soft material, preferably a thermoplastic elastomer, such as silicone, so that it is comfortable yet offers a relatively tight seal with the patient.

Mask body 38 supports seal member 40 and is typically formed from a material that is more rigid than the seal member, such as a rigid or semi-rigid plastic. Mask body 38 can also provide attachment points for headgear (not shown) for securing the mask to the patient.

Mask body 38 and mask seal member 40, individually and collectively, define a cavity 42 that is adapted to receive a portion of the user, such as the user's nose as shown in FIG. 1. A first opening 44 is defined in one end of mask body 38 and a second opening 46 having a peripheral edge 48 is defined at the other end of the mask body. The first opening serves as coupling for the flexible conduit so that the flow of breathing gas from the gas source is communicated to cavity 42. A first end 50 of mask seal member 40 is secured to mask body 38 at peripheral edge 48 using a two-shot injection molding technique so that an airtight joint 52 securely couples the mask body and the mask seal member. An opening 54 is provided in a second end 56 of mask seal member 40 for receiving a portion of the patient, such as the patient's nose, so that an airway of the patient communicates with cavity 42. Second end 56 of mask seal member 40 overlies the patient and forms a seal between the mask and the patient that minimizes or preferably has no gas leaks during operation of the pressure support system.

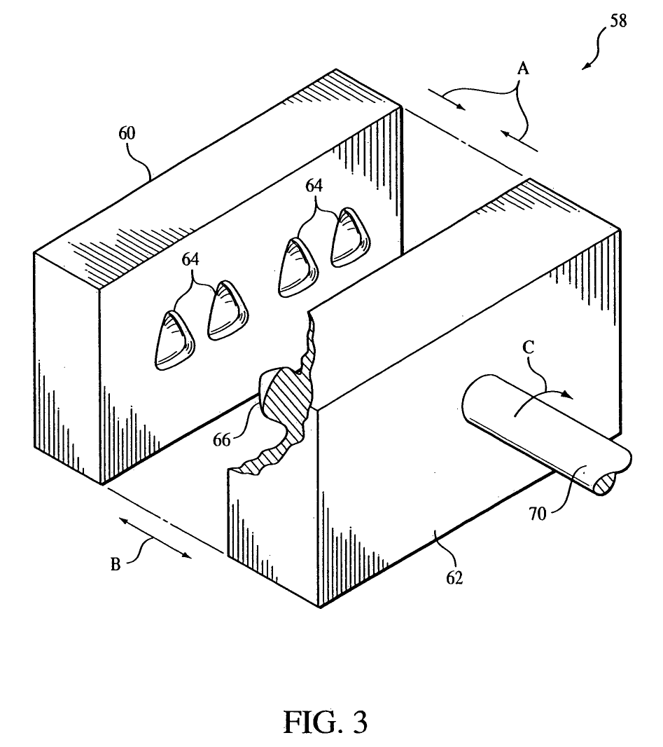

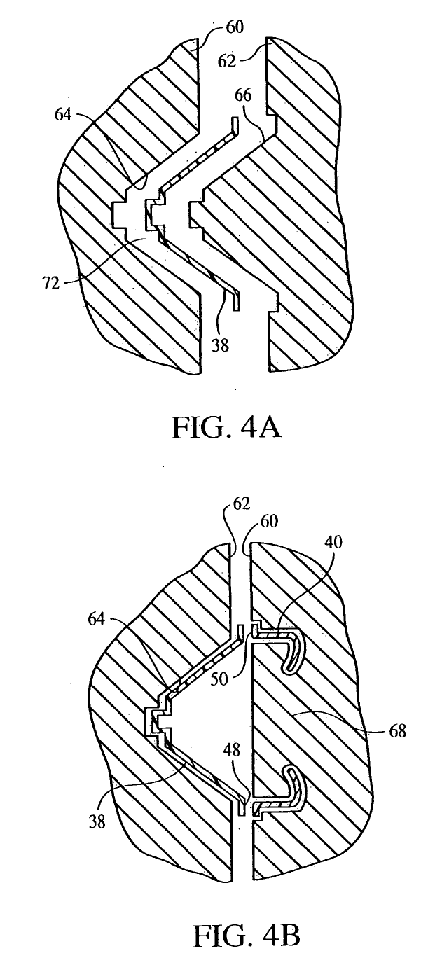

The two-shot injection molding process for forming mask 30 is described below with reference to FIG. 3, which is a schematic diagram of the die sections of an injection molding apparatus 58, and with reference to FIG. 4A-4B; which are cross-sectional schematic views of a portion of the injection molding apparatus. Injection molding apparatus 58 includes a first section 60 and a second section 62 that press together, as indicated by arrow A, to define a mold for forming a mask. First and second sections 60 and 62 are separable, as indicated by arrow B, to eject molded masks from the molding apparatus and to realign mold portions, as described below. First section 60 includes first mask body mold portions 64 that cooperate with second body mold portions 66 and mask seal mold portions 68 provided in second section 62 to form a complete mold for forming the mask body and mask seal member.

In a preferred embodiment of the present invention, one or more second body mold portions 66 are provided on one side of second section 62 in alignment with a first set of first body mold portions 64 on first section 60, and an equal number of mask seal mold portions 68 are provided on the other side of second section 62, also in alignment with another set of first body mold portions 64 in first section 60. The cooperation of first body mold portions 64 and second body mold portions 66, as shown in FIG. 4A, forms mask body 38. Similarly, the cooperation of first body mold portions 64 and seal mold portions 68, as shown in FIG. 4B, forms mask seal member 40 bonded to mask body 38. As shown in FIG. 3, the sections of the injection molding apparatus are rotatable relative to one another, for example on a shaft 70 as indicated by arrow C, to provide separate alignments of first mask body mold portions 64 with second body mold portions 66 and then with mask seal mold portions 68.

More specifically, first body mold portions 64 provide the surface outline of the exposed or outer surface of mask body 38, and second body mold portions 66 provide the surface outline of the interior surface of the mask body. When first and second body mold portions 60 and 62 are pressed together, first body mold portions 64 and second first body mold portions 66 mate to form complete molds for forming mask body 38 in a gap 72 therebetween. Although not illustrated, one or both of first section 60 and second section 62 includes structures for controlling the injection of material, such as molten plastic, into gap 72 defined between the first and second sections, i.e., between first body mold portions 64 and second body mold portion 66. This material supplied to gap 72 cures to a hard, structural plastic material, that forms mask body 38.

Preferably before curing of mask body 38 is complete, first section 60 and second section 62 are separated in such a manner that mask body 38 remains within first body mold portion 64. First section 60 and second section 62 are then realigned, for example, by rotating the second section 180° relative to the first section or by rotating the first-section 180° relative to the second section, so that the first body mold portions containing the curing mask body are brought into registration with seal mold portions 68 of second section 62, as shown in FIG. 4B. It should be noted that first section 60 and second section 62 are illustrated in FIG. 4B as being separated from one another for ease of illustration purposes and so that the details of the mold portions can be clearly visualized. In actual use, first and second sections 60 and 62 are pressed together to form a second mold for forming mask seal member 40 bonded to mask body 38. As schematically shown in FIG. 4B, first end 50 of mask seal member 40 is joined to peripheral edge 48 of second opening 46.

The hard plastic of mask body 38 begins cooling and curing immediately after injection of molten plastic ceases. Preferably, the molding of mask seal member 40 to mask body 38 is performed while the mask body is still curing and cooling so that the material defining mask seal member 40, such as silicone, molecularly bonds with the as-yet uncured material of mask body 38, thereby forming a secure, airtight bond between the mask body and the mask seal member at joint 52. Accordingly, the separation, rotation, and re-engagement of first and second sections 60 and 62 takes place as soon as the newly formed mask body has cooled to a sufficient extent to be self-supporting when second body mold portions 66 are removed from first body mold portions 64.

Finally, first and second sections 60 and 62 are separated and the completed mask 30 is removed from the injection molding apparatus. It can be appreciated that the construction of the molding apparatus in this manner makes it possible to form the mask body on one half of the apparatus and simultaneously form the mask seal member in bonded relation with the mask body on the other half of the injection molding apparatus. In particular, when first and second sections 60 and 62 are pressed together, two mask bodies are formed on a first side of the apparatus using first and second body mold portions 64 and 66, while simultaneously two previously-formed mask bodies are molded to the mask seal member on a second side of the apparatus using first body mold portion 64 and seal mold portions 68. When first and second sections 60 and 62 are subsequently separated, two completed masks are formed in the second side of the apparatus.

It should be noted that the joint between the mask body and mask seal member in FIG. 1-2 is slightly different than the joint between the mask body and mask seal member shown in FIG. 4A-4B. This is done to illustrate the fact that the present invention contemplates that a wide variety of different surface mating interface configurations can be provided for the joint between the mask body and the mask seal member. For example, interlocking contours can be provided at the mating ends of the mask body and the mask seal member for increasing the surface area of the bonded region between these two components of the mask, thereby increasing the sealing strength of joint 52. Also, the ends of the mask body and the mask seal member need not be abutting, as shown in the figures, but may be provided in an overlapping fashion, alone or in combination with an abutting relation, so long as a sufficient bond is provided between these portions of the mask.

Mask 30 is a full face mask that it seals over both the user's nares and mouth. It is to be understood, however, that the present invention contemplates that the mask formed using this molding technique can be sized and configured as a nasal mask, which only seals over the user's nares, leaving the mouth uncovered. In addition, the mask body, mask seal member (also known as mask cushion), or both can have a variety of configurations, shapes, and sizes in addition to those illustrated in the figures and can include other features. The only constraints on the variety of different configurations, shapes, and sizes for these components are the physical limitations of the molding apparatus. In addition, the mask body and/or mask seal member can include additional items, such as headgear attachment points, pressure ports, and exhaust ports, not shown in the illustrated exemplary embodiments.

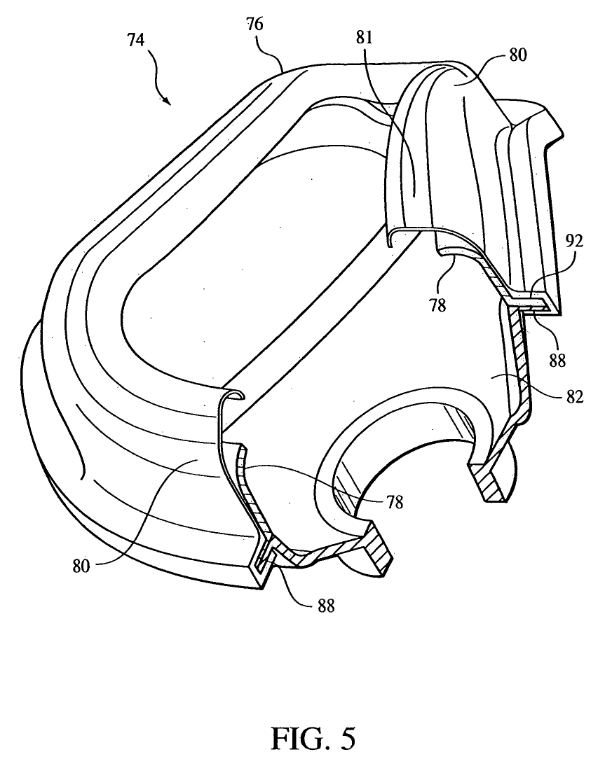

Furthermore, the mask body, mask seal member, or both need not be formed from unitary structures as shown in FIG. 1-4B. On the contrary, the present invention contemplates, for example, providing a mask 74 having a mask seal member 76 that is defined by a combination of a first flap member 78 (a.k.a. first cushion) and a second flap member 80 (a.k.a. second cushion), as shown in FIG. 5-7. In this embodiment, second flap member 80 is mechanically coupled to the mask body 82 such that it generally overlies first flap member 78 and serves as the patient contacting portion of the mask seal member 76. Preferably, at least a distal end 81 of second flap member 80 is formed from a relatively flexible and soft material to provide a comfortable surface for contacting the patient while providing a good seal with the surface of the patient.

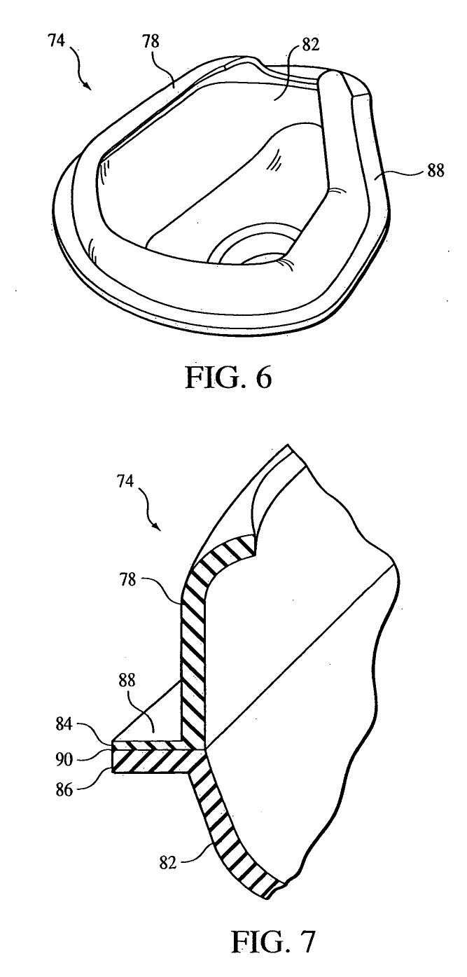

First flap member 78, which is illustrated by itself in FIG. 6, is generally more rigid than second flap member so that the first flap member provides a greater degree of structural support for the mask seal member than is possible by the relatively flexible second flap member alone. This is especially important as the mask is strapped more tightly on the patient. In this embodiment, first flap member 78 is the portion of the mask seal member that is molded to a mask body 82 using the above described two-shot injection molding technique. As described in greater detail below, second flap member 80 is preferably not permanently attached to the mask, but is mechanically fastened to the mask. First and second flap members can be formed from the same or different substances.

As shown in FIG. 7, an end 84 of first flap member 78 and an end 86 of mask body 82 are joined in such a manner that a flange 88 is provided along the circumference of mask 74. Because ends 84 and 86 are bonded together while the material of mask body 82 is incompletely cured, ends 84 and 86 effectively fuse together at joint 90, thereby providing an airtight and strong interconnection between the mask body and the first flap member.

Flange 88 serves as an attachment mechanism for removeably securing second flap member 80 to mask 74. More specifically, second flap member 80 includes a channel 92 adapted to receive flange 88 so that the second flap member generally overlies the first flap member when the mask is fully assembled. This configuration for the second flap member allows the second flap member to be easily replaced or cleaned and also allows differently sized or configured second flap members to be used in combination with a common mask body/first flap member assembly, thereby simplifying and reducing the number of parts required to provide a mask that effectively fits a wide range of patients.

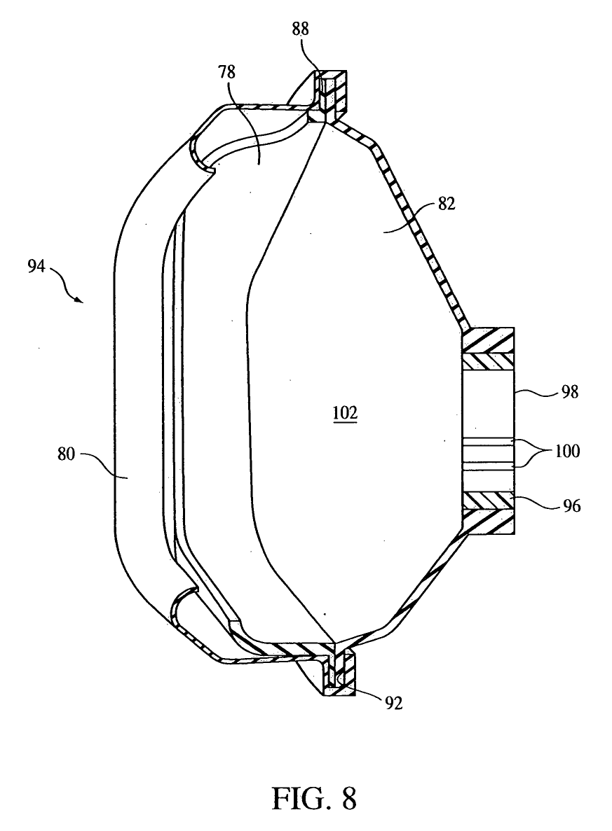

In the embodiments of the mask described above, the mask body and mask seal member are formed and joined by a two-shot injection molding technique, thereby avoiding the need for a separate adhesive for mechanical joining of these two mask components. It is to be understood, however, that the present invention contemplates forming other components of the mask using the above-described two-shot injection molding technique. FIG. 8, for example, is a cross-sectional view of a mask 94 that is similar in many respects to mask 74, except that mask 94 includes a coupling member 96 molded to mask body 82 generally at a first opening 98. Coupling member 96, like first flap member 78, is bonded to mask body 82 by means of the two-shot injection molding process while the mask body is cooling and incompletely cured so that a portion of the coupling member is molecularly bonded to the mask body. Coupling member 96 is preferably formed from a material that is relatively more deformable than the material of mask body 82 so that the mask can be easily, yet snuggly fitted to the end of a patient circuit.

In a preferred embodiment, coupling member 96 attaches to a collar portion (not shown) that includes headgear attachment points for securing mask 94 to a patient. Coupling member 96 can also include channels 100 defined therein for assisting in correctly aligning mask 94 on the end of a patient circuit.

The present invention contemplates forming coupling member 96 at the same time first flap member 78 is formed. This can be accomplished, for example, by configuring the seal mold portions of the injection molding apparatus to provide the material that forms the coupling member through mask cavity 102 to an area proximate to first opening 98 of mask body 82. Alternatively, or in addition, channels can be defined in the interior and/or exterior surface of body member 82 or in the surface of the mold that forms either of these surfaces, so that the material that forms the seal can flow to the area proximate to first opening 98 of mask body 82 to form the coupling member. The present invention also contemplates providing a third injection molding step for forming the coupling member. This third molding preferably is performed either before or after the mask seal member is formed and while the mask body is cooling and incompletely cured, so that a portion of the coupling member is molecularly bonded to the mask body.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims.

What is claimed is:

1. A mask adapted to communicate a flow of breathing gas with an airway of a user, the mask comprising:
a mask body having a first opening adapted to be coupled to a source of breathing gas and a second opening; and
a mask seal member defining a user contacting portion that couples the mask body to a user so as to enable the flow of breathing gas to be delivered to an airway of such a user, and wherein at least a portion of the mask seal member is molded to the mask body generally at the second opening by a two-shot injection molding process while the mask body is cooling and incompletely cured so that a portion of the mask seal member is molecularly bonded to the mask body as a consequence of the two-shot injection molding process.

2. The mask of claim 1, wherein the mask seal includes a first flap member and a second flap member that generally overlies the first flap member responsive to the mask being in an assembled configuration, wherein the first flap member is the portion of the mask seal member that is molded to the mask body.

3. The mask of claim 2, wherein the second flap member is removeably attachable to the mask body.

4. The mask of claim 1, further comprising a coupling member molded to the mask body generally at the first opening by a two-shot injection molding process while the mask body is cooling and incompletely cured so that a portion of the coupling member is molecularly bonded to the mask body as a consequence of the two-shot injection molding process.

5. The mask of claim 1, wherein the mask body is defined by a plastic.

6. The mask of claim 1, wherein the mask seal member is unitary piece of silicone material.

7. The mask of claim 1, wherein the mask body includes a cavity defined therein and a peripheral edge defined at the second opening, wherein the second opening is adapted to communicate the cavity with at least a portion of a nose of a user, and wherein the first opening communicates with the cavity and provides a coupling adapted to couple to a conduit that carries the flow of breathing gas to the cavity.

8. The mask of claim 7, wherein the mask seal member is disposed on the peripheral edge of the mask body.

9. A pressure support system comprising:
a pressure generator adapted to provide a flow of breathing gas;
a conduit operatively coupled to the pressure generator to deliver the flow of breathing gas to a user; and
a mask coupled to the conduit to communicate the flow of breathing gas to an airway of a user, the mask comprising:
a mask body coupled to the conduit; and
a mask seal member having at least one portion that is molded to the mask body by a two-shot injection molding process while the mask body is cooling and incompletely cured, wherein the portion of the mask seal member is molecularly bonded to the mask body as a consequence of the two-shot injection molding process.

10. The system of claim 9, wherein the mask seal includes a first flap member and a second flap member that generally overlies the first flap member responsive to the mask being in an assembled configuration, wherein the first flap member is the portion of the mask seal member that is molded to the mask body.

11. The system of claim 10, wherein the second flap member is removeably attachable to the mask body.

12. The system claim 9, further comprising a coupling member molded to the mask body generally at a location where the conduit coupled to the mask by a two-shot injection molding process while the mask body is cooling and incompletely cured so that a portion of the coupling member is molecularly bonded to the mask body as a consequence of the two-shot injection molding process.

13. The system of claim 9, wherein the mask body is defined by a plastic.

14. The system of claim 9, wherein the mask seal member is defined by a unitary piece of silicone material.

15. The system of claim 9, wherein the mask body includes:
a nose receiving cavity defined therein;
a first end portion having a peripheral edge;
a second end portion generally opposite the first end portion;
a first opening defined in the first end portion adapted to receive at least a portion of a nose of a user such that nares of a user communicate with the nose receiving cavity in the mask body; and
a second opening defined in the second end portion, the second opening communicating with the nose receiving cavity and providing a coupling for the conduit.

16. The system of claim 15, wherein the mask seal member is disposed on the peripheral edge of the first end portion of the mask body.

17. A two-shot injection molding method of forming a mask that is adapted to communicate a flow of breathing gas with an airway of a user, the method comprising:
providing a mask mold;
injecting a first material into the mask mold to define a mask body of the mask;
injecting a second material into the mask mold while the mask body is cooling and incompletely cured to define at least a portion of a mask seal member of the mask, wherein the mask seal member is molecularly bonded to the mask body as a consequence of the second material being injected into the mask mold in this manner.

18. The method of claim 17, wherein injecting a second material into the mask mold defines a first flap member of the mask seal member and further comprising a second flap member that generally overlies the first flap member responsive to the mask being in an assembled configuration.

19. The method of claim 18, wherein the second flap member is removeably attached to the mask body to define an assembled mask.

20. The method of claim 17, wherein injecting the second material into the mask mold also defines a coupling member molded to the mask body.

21. A mask adapted to communicate a flow of breathing gas with an airway of a user manufactured according to a two-shot injection molding process comprising the steps of:
providing a mask mold;
injecting a first material into the mask mold to define a mask body of the mask;
injecting a second material into the mask mold while the mask body is cooling and incompletely cured to define a mask seal member of the mask, wherein the mask seal member is molecularly bonded to the mask body as a consequence of the second material being injected into the mask mold in this manner.

22. The mask of claim 21, wherein injecting a second material into the mask mold defines a first flap member of the mask seal member and further comprising a second flap member that generally overlies the first flap member responsive to the mask being in an assembled configuration.

23. The mask of claim 21, wherein the second flap member is removeably attached to the mask body to define an assembled mask.

24. The mask of claim 21, wherein injecting the second material into the mask mold also defines a coupling member molded to the mask body.
